(19) United States
(12) Patent Application Publication
(10) Pub. No.: US 2025/0391138 A1
(43) Pub. Date: Dec. 25, 2025

(54) Platform Agnostic System For Spatially Synchronization Of Physical And Virtual Locations

(71) Applicants: Stanley Ezell Walker, Orlando, FL (US); Jack Rebbetoy, San Anselmo, CA (US); Clark Dodsworth, Santa Fe, NM (US); Jack Gruber, New York, NY (US)

(72) Inventors: Stanley Ezell Walker, Orlando, FL (US); Jack Rebbetoy, San Anselmo, CA (US); Clark Dodsworth, Santa Fe, NM (US); Jack Gruber, New York, NY (US)

(21) Appl. No.: 18/878,885

(22) PCT Filed: Jul. 31, 2023
(86) PCT No.: PCT/US2023/029150

§ 371 Date: Dec. 25, 2024

Related U.S. Application Data
(60) Provisional application No. 63/393,970, filed on Jul. 31, 2022.

(51) Int. Cl. G06T 19/20; A63F 13/211; A63F 13/212; A63F 13/216; A63F 13/25; G06F 3/01; G06F 3/02; G06F 3/0346

(52) U.S. Cl. CPC G06T 19/20; A63F 13/211; A63F 13/212; A63F 13/216; A63F 13/25; G06F 3/012; G06F 3/017; G06F 3/02; G06F 3/0346; G06T 2219/024; G06T 2219/2004; G06T 2219/2016

(57) ABSTRACT

A computer implemented platform agnostic system for spatial synchronization of physical and virtual locations that provide user experiences to be created or where local and remote users can interact. The system having a central server, at least one XR headset connected to the central server, and instructions executable on the server and XR headset for mapping a physical location into a digital twin or shared XR virtual environment; mapping a shared XR virtual environment; interacting with the one or more than one shared XR virtual environment; tracking one or more than one user accurately in both the physical and the one or more than one XR virtual environment without needing expensive equipment external to the one or more than one users' XR headset integrated display system, wherein the executable instructions are platform agnostic; and controlling the XR virtual environment, assets, content, theme, script/narrative, and interactions in real-time.

### CROSS-REFERENCE TO RELATED APPLICATIONS

The present Application claims the benefit of and is a national stage of International Patent Application No. WO PCT/US23/29150, titled “Platform Agnostic System For Spatially Synchronization Of Physical And Virtual Locations,” filed Jul. 31, 2023, which claims priority from under 35 U.S.C. § 119(e) of U.S. Provisional Patent Application Ser. No. 63/393,970, filed on Jul. 31, 2022, both contents of which are incorporated herein by reference in their entirety.

### FIELD OF THE INVENTION

The present invention is in the technical field of virtual, augmented, mixed and extended reality and more particularly to a platform agnostic system for spatial synchronization of physical and virtual locations that provide user experiences to be created where local and remote users can interact.

### BACKGROUND

The currently available virtual reality (VR) and other related categories, including augmented reality (AR), mixed reality (MR) and extended reality (XR) hardware and software does not have the capability to see and interact with other users and 3D models in a space in a positionally accurate, rotationally accurate, scale-accurate, and platform agnostic way. Additionally, current systems do not have an accurate method for mapping physical locations to create a digital twin in XR. Also, current systems do not have an effective and practical set of methods to augment, edit, or otherwise modify a digital twin during the process of mapping a physical environment, or a created XR virtual environment 112 model. Current systems are slow and oriented to vertical market uses, thus are not general-purpose and do not have user interfaces that conform to best practices of user interface design and user experience design. Further, they are not extensible or sufficiently extensible, have limited file import capability, and are not platform, device and communications modality agnostic, such as, voice first, and able to handle commands that are a combination of voice, gesture, and controller. Further, they do not have the ability to make calls to AI/ML servers to interpret commands that include voice and other modalities. Additionally, current systems do not have an effective and practical set of methods to augment or otherwise modify a digital twin or other 3D model while a user is immersed in that model. Additionally, current systems do not have an effective and practical set of methods to do the above that can also be used to define, build, create, ‘sketch’ a 3D model/virtual environment without mapping a physical location.

Custom home mapper from Sidequest® VR and Meta®'s Oculus room mapper are currently available. However, the mapping in these prior art products is less accurate and doesn't persist between sessions. This requires the user to re-map their location before every new session, wasting time, resources, and frustrating users. Custom home mapper lets a user recreate the user's house in VR and customize it. Custom Home Mapper turns the user's standalone headset into a location-based VR arcade. Users can map the physical layout of their homes, including any furniture or obstructions, and participate in a variety of simple mini-games that require them to move throughout their physical location. Disadvantageously, it is not practical to use as it does not maintain persistent sync for users correctly between sessions and due to this, the users have to re-map the location each time they start a session.

There are wall mapping experiences for the Oculus® line of VR hardware, such as Oculus Guardian®, which is a built-in safety feature that lets users set up boundaries in VR that appear when a user gets too close to the edge of a user's activity area. Oculus also has a visually based virtual 3D mapper similar to a custom home mapper, but placing walls visually leads to multiple positional, rotational, and scale inaccuracies. Their solution also has a similar positional persistence issue to custom home mapper. Unfortunately, the visual-based method used is not as accurate as the system described herein. This inaccuracy can lead to user accidents and even injuries. Also, the by-hand mapping process can take days to complete. This wastes users' time and resources for limited playability and scalability.

Moreover, currently available prior art solutions, such as the above-mentioned platforms and others, similar to Space Pirate Arena®, do not have the ability for other users to virtually join a shared physical location. Space Pirate Arena® allows tracking of physical players but doesn't allow for local and remote users to play in a shared space at the same time.

Another disadvantage of current systems is the fact that they are hardware-locked to a specific platform. XR users with different hardware are not able to utilize some or all of the capabilities in another platform.

Therefore, there is a need for a platform agnostic extensible, such as, modular and configurable system that enables control by voice, controller, gesture, and combinations thereof to the benefit and convenience of the user, for spatial synchronization of a local physical and a remote XR virtual environment 112 that provide user experiences to be created where local and remote users can interact with one another and virtual objects, including 3D models, and create, modify, manipulate, evaluate, and edit such 3D models and virtual objects in the XR virtual environment 112, using more effective and efficient user interfaces and user interface design best practices, overcoming the limitations of the prior art.

### SUMMARY

The system overcomes the limitations of the prior art by providing a computer implemented platform agnostic system for spatial synchronization of physical and virtual locations that provide user experiences to be created or where local and remote users can interact. The system comprises of: one or more than one central server, wherein the one or more than one central server comprises one or more than one processor. One or more than one XR headset operably connected to the one or more than one central server, wherein the XR headset comprises one or more than one processor, and instructions executable on the one or more than one central server and the one or more than one XR headset. The instructions comprise first, mapping one or more than one physical location or object into a digital twin. Then, mapping one or more than one shared XR virtual environment. Next, interacting with the one or more than one shared XR virtual environment. Then, tracking one or more than one user accurately in both the physical and the one or more than one XR virtual environment without needing expensive equipment external to the one or more than one users' XR headset integrated display system, wherein the executable instructions are platform agnostic. Finally, controlling the XR virtual environment, assets, content, theme, script/narrative, and interactions in real-time. The system further comprises one or more than one XR hand controller, voice recognition and command functionality, gesture recognition and command functionality, and a real-time, spatially accurate, multi-user voice communications system operably connected to the one or more than one XR headset.

The one or more than one user is co-located with other users in a physical location and with other non-collocated users that can virtually join in the physical location from arbitrary remote locations to have a common experience in the XR environment where the users can interact with each other. The user can correctly, quickly, and accurately position the virtual bounding walls and elements of a physical location, creating a digital twin with accurate lengths and heights of the physical location using the one or more than one XR hand controller, one or more than one voice command, one or more than one gesture command, or a combination thereof.

The system comprises instructions for one or more than one user to iteratively plot a plurality of reference points for the layout of an entire physical location to create an aligned digital twin of the physical location and any additional virtual features that are not present in the physical location. The instructions comprise first, identifying a first point by touching the one or more than one XR hand controller or the user's hand at a first point and pressing a first XR hand controller button, issuing a voice command, a gesture command or a combination thereof. Then, identifying a second point by moving to a second point of and pressing a second XR hand controller button, issuing a second voice command, a second gesture command or combination thereof. Next, calibrating the alignment and rotation of the first point and the second point. Then, generating an XR virtual environment defined by the first point and the second point. Next, repeating the steps above in the physical location until the area is completely identified. Finally, fully mapping a digital twin of the physical location in the XR virtual environment by pressing a third XR hand controller button, issuing a third voice command, a third gesture command, or a combination thereof, to merge the points and any additional virtual penetrations 304, extrusions 302, or other virtual features.

The system also comprises a library of objects and assets that can be quickly added to the digital twin. The digital twin can be configured to support various gaming and other fantasy or real location layouts. The system further comprises instructions to: import or access saved, persistent, user-created content, and third-party content into the digital twin of the XR virtual environment; and to add virtual elements to the existing XR virtual environment and modify or remove elements of the XR virtual environment, using mapping methods and save the resulting digital twin. The system further comprises instructions to scale, rotate, translate, tilt, and/or orient the digital twin, of an inside physical location or of an outside physical object, an outside physical location or another 3D model, to whatever size, orientation, and position selected by the user in the XR virtual environment.

The system executes instructions for spatial synchronization of one or more than one user located in a physical location using a controller synchronization method. The controller synchronization method comprise instructions operable on a processor by first, placing a controller in a predefined location by a first user. Then, identifying a first point by pressing a first button on the controller, issuing a first voice command, or a first gesture command by the first user. Next, placing a second controller in the same or different predefined location, by a second user. Then, identifying a second point by pressing a second button on the second controller, issuing a second voice command or a second gesture command by the second user. Next, synchronizing both the first user and the second user in an XR virtual environment bounded by a location and apparatus, enabling both the first user and the second user to move about the location and apparatus and the XR virtual environment freely. Finally, repeating steps above to add additional users. After the users are synchronized, the system provides real-time tracking, free-roaming, manipulation and interaction with some virtual elements, and social interaction of the one or more than one user in both the physical location and the XR virtual environment in a single shared XR virtual environment, wherein the system is scalable in any instance for any amount of users located anywhere.

The system performs spatial synchronization of one or more than one user in a physical location using a headset synchronization method. The headset synchronization method comprises instructions operable on a processor for the user to step on a first predefined point and staring straight ahead. Then, synchronizing the first user by the first user pressing a button on a first controller, using a first verbal command, using a first gesture command, or a combination thereof. Next, moving away from the first predefined point by the first user. Then, stepping on the first predefined point or a second predefined point and staring straight ahead by a second user. Next, synchronizing the second user by the second user pressing a button on a second controller, using a second verbal command, using a second gesture command, or a combination thereof. Then, positionally synchronizing the first user and the second user in an XR virtual environment and in the selected physical environment; wherein both the first user and the second user are able to move about the physical location and the XR virtual environment freely. Finally, repeating the steps above to add other users. The system further comprises the step of displaying in the headset a cross hair graphic and orienting the headset using the cross hair graphic to a specified marker in the physical environment to enhance precision. After the one or more than one user is synchronized, the system enables real-time tracking, free-roaming, manipulation of and interaction with virtual elements, and social interaction of the one or more than one user in both the physical location and the remote XR virtual environment in a single shared XR virtual environment, wherein the system is scalable in any instance for any amount of users located anywhere. The system also has instructions for tracking physical objects using one or more than one motion tracking technology, and having the physical objects appear in the XR virtual environment with the correct features.

The one or more than one user can quickly switch content with avatars of inhabiting users, to effect a different XR virtual environment experience, or scenario, in the same physical room, within the same XR virtual environment platform, or imported from a different XR virtual environment platform, all in the original physical location, creating new XR content, an XR virtual environment, or scenario easily and quickly; wherein the new XR virtual environment, content, or scenario also includes an entire 3D dataset. The system further comprises real-time monitoring of game sessions and user interactions, with event logging, casting, session recording and other functions. A default, automatic standard generic profile, is generated for every new user, with prompts to customize the profile.

The customized profile is managed, accretes and incrementally auto-updates a log of the user's behavior data from each return visit, using artificial intelligence and machine learning methods to create an incrementally refined model of the user, to incorporate in real-time dynamic XR experience creation for the user and others; wherein the artificial intelligence and machine learning sets are auto-adjusted to suit the user's skill level and are synchronized across all users in the system.

### BRIEF DESCRIPTION OF THE DRAWINGS

The present invention overcomes the limitations of the prior art by providing a platform agnostic system for spatial synchronization of physical and virtual locations that provide user experiences to be created where local and remote users can interact.

These and other features, aspects, and advantages of the present invention will become better understood with regard to the following description, appended claims, and accompanying figures where:

FIG. 1 is a diagram of a system for a platform agnostic system for spatial synchronization of physical and virtual locations that provide user experiences to be created where local and remote users can interact, according to one embodiment of the present invention;

FIG. 2 are diagrams of a virtual 3D mapper workflow that provide XR user experiences to be created where the users can interact in the system of FIG. 1;

FIG. 3 is a diagram of user interaction with a user interaction with the digital twin digital twin;

FIG. 5 is a flowchart diagram of some instructions for one or more than one user to iteratively plot a plurality of reference points for the layout of an entire physical location to create an aligned digital twin of the physical location or 3D object and any additional virtual features that are not present in the physical location;

FIG. 6 is a flowchart diagram of some steps of a method for controller synchronization of one or more than one user in an XR virtual environment; and

FIG. 7 is a flowchart diagram showing some steps of a method for headset synchronization of one or more than one user in an XR virtual environment

### DETAILED DESCRIPTION OF THE INVENTION

The present invention overcomes the limitations of the prior art by providing a means to enable anyone in any industry to bring local and remote users together spatially and seamlessly, in one shared place. The system 100 provides seamless synchronization and registration of three-dimensional space, time, and sound in one location for multiple users, plus many other users located anywhere else. The system 100 allows for a fully immersive multi-user virtual experience, together and at scale. The system 100 allows for global shared interaction with real or created people, places, things, phenomena, eras, worlds, events, and transactions. The system 100 provides improvements in the user interface elements and the user experience design that attend to know best practices in order to benefit users by enabling more efficient and effective use of the system's 100 features and functions than current systems, overcoming the limitations of the prior art.

The present invention is a platform agnostic system 100 for accurate and rapid spatial synchronization of physical and virtual (remote) locations that provide user experiences to be created and modified, in which the local and remote users can interact. A quick method to map and modify or extend a physical location while mapping it is valuable to entertainment experience design, including location-based entertainment (LBE) and digital game design, and to other commercial, non-entertainment uses including but not limited to: architectural and engineering; military; law enforcement; government; training and education; e-commerce; focus-group testing; surveys; crowd-participation multi-player experiences at events; manufacturing; construction; building and campus operations management; and a host of other vertical industries and applications where tasks, processes, or entertainment are or can be executed in an arbitrarily, dynamically adjustable combination of physical and virtual space and physical and virtual abilities to alter the environment and elements. Additionally, quick, accurate mapping can be a component of the ability to turn any physical location, building, object, or installation into a digital twin 110 instance and recreate it in XR without much training or effort, overcoming a major limitation of the prior art. There is also provided, methods for quick, accurate spatial definition of an XR virtual environment 112, that can also be described as building, creating, and ‘sketching’ a 3D model/XR virtual environment 112 and subsequently modifying it without mapping a physical location. The system 100 is also useful for design professionals in a variety of industries and also to individuals for leisure activities and entertainment applications.

Similarly, the quick method to map, alter, annotate, record, and perform other actions upon and activities within a shared XR virtual environment 112 or space is valuable in many other industries, such as, for example: public safety, education, and others, where time is valuable and additional revenues can be collected or expenses reduced by adding the XR virtual space and any number of diverse virtual functions in addition to the physical facility.

The system 100 provides a framework by which any of these commercial or government applications can add remote users to a shared XR virtual environment 112, which could speed content production and project delivery, increase revenue, reduce costs, extend programmatic activities, enhance utility, or increase throughput significantly.

The system 100 is also platform agnostic, for use on a variety of XR software and hardware platforms, and devices, that includes all versions of the technology, including virtual reality, augmented reality, mixed reality, and XR devices. The system 100 is typically, but not limited to, headsets that are used in dynamically customizable multi-user sessions or experiences for a diversity of uses including entertainment, presentation, collaborative design, review, training, monitoring, education, and inspection functions. Such as, for example, compliance, safety, and validation, among others. The system 100 also tracks users' locations and actions accurately without requiring expensive equipment external to the users' wearable systems 100 or other systems associated with users to extend or augment their awareness and/or knowledge via one or more sensory modalities. The system 100 is also display agnostic, because it allows users to use flat-screen displays to utilize the technology without the use of a headset or a head-mounted display system.

The system 100 allows users to co-locate (be present with other users in a physical location while using a virtual model XR virtual environment 112 or virtual XR elements/objects displayed within the physical location. In addition, the system 100 allows other users who are not co-located to virtually join in the XR virtual environment 112 extant in the physical location from arbitrary remote locations and to share a common multi-sensory experience at 1:1 scale and adjustable other scales, and to control the scale, orientation, and other features of the virtual elements in the XR virtual environment 112 of the co-located experience in arbitrary ways, many of which are beneficial and of utility. Users who have entered the synchronized XR virtual environment 112 represented in a physical location will perceive other users who have entered from remote locations, as represented by the user's avatars, behaviors, and voices, to also be co-located in the XR virtual environment 112 in the same physical location.

The possibilities for the system 100 are nearly limitless, beyond the ability for games to be experienced together. Such as, for example, family reunions, birthdays, ceremonies, and other events for even the most physically distant relatives, friends, or colleagues. Business uses include collaborative design, virtual presentations and walkthroughs of locations, systems, and objects, training sessions, inspections, and education. One example is the ability for safety personnel in diverse physical locations to jointly view, annotate, record, operate within, and evaluate dangerous locations, remote or local, robotically without danger. Other examples include joint training for military, firefighting, police, healthcare, industrial, construction, architectural, building operations, live performance, and other teams/groups regardless of personnel locations. An arbitrary number of team members can be located elsewhere, while interacting as if every user is in the same, physical location. Such physical locations may be, for example, a real building, ship at sea, space vehicle in space, or habitation on a moon or other celestial body, or other complex object, all of the above with any arbitrary overlay of virtual elements, or an entirely virtual design.

All of these scenarios and more are possible with the present invention by creating a digital twin 110 of a physical location or object, augmenting it with virtual features during or after creation of the digital twin 110, synchronizing local users in their physical location, and allowing remote users to join and interact in that same synchronization as if they were physically present. In addition, the system 100 can be used to create a 3D model of arbitrary design and complexity for use in an XR virtual environment 112 without recourse to a physical structure to map. Such created models can be edited, modified, augmented, and combined with others, including digital twins 110, in XR virtual environments 112, and synchronized for local and remote users.

All dimensions specified in this disclosure are by way of example only and are not intended to be limiting. Further, the proportions shown in these Figures are not necessarily to scale. As will be understood by those with skill in the art with reference to this disclosure, the actual dimensions, and proportions of any system, any device or part of a system or device disclosed in this disclosure will be determined by its intended use.

Methods and devices that implement the embodiments of the various features of the invention will now be described with reference to the drawings. The drawings and the associated descriptions are provided to illustrate embodiments of the invention and not to limit the scope of the invention. Reference in the specification to “one embodiment” or “an embodiment” is intended to indicate that a particular feature, structure, or characteristic described in connection with the embodiment is included in at least an embodiment of the invention. The appearances of the phrase “in one embodiment” or “an embodiment” in various places in the specification are not necessarily all referring to the same embodiment.

Throughout the drawings, reference numbers are re-used to indicate correspondence between referenced elements. In addition, the first digit of each reference number indicates the figure where the element first appears.

As used in this disclosure, except where the context requires otherwise, the term “comprise” and variations of the term, such as “comprising,” “comprises,” and “comprised” are not intended to exclude other additives, components, integers, or steps.

In the following description, specific details are given to provide a thorough understanding of the embodiments. However, it will be understood by one of ordinary skill in the art that the embodiments may be practiced without these specific details. Well-known circuits, structures, and techniques may not be shown in detail in order not to obscure the embodiments. For example, circuits may be shown in block diagrams in order not to obscure the embodiments in unnecessary detail.

Also, it is noted that the embodiments may be described as a process that is depicted as a flowchart, a flow diagram, a structure diagram, or a block diagram. The flowcharts and block diagrams in the figures can illustrate the architecture, functionality, and operation of possible implementations of systems, methods, and computer programs according to various embodiments disclosed. In this regard, each block in the flowchart or block diagrams can represent a module, segment, or portion of code, that can comprise one or more executable instructions for implementing the specified logical function(s). It should also be noted that, in some alternative implementations, the functions noted in the blocks may occur out of the order noted in the figures. Although a flowchart may describe the operations as a sequential process, many of the operations can be performed in parallel or concurrently. In addition, the order of the operations may be rearranged. A process is terminated when its operations are completed. A process may correspond to a method, a function, a procedure, a subroutine, a subprogram, etc. When a process corresponds to a function, its termination corresponds to a return of the function to the calling function or the main function. Additionally, each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Moreover, a storage may represent one or more devices for storing data, including read-only memory (ROM), random access memory (RAM), magnetic disk storage mediums, optical storage mediums, flash memory devices and/or other non-transitory machine-readable mediums for storing information. The term “machine readable medium” includes but is not limited to portable or fixed storage devices, optical storage devices, wireless channels and various other non-transitory mediums capable of storing, comprising, containing, executing or carrying instruction(s) and/or data.

Furthermore, embodiments may be implemented by hardware, software, firmware, middleware, microcode, or a combination thereof. When implemented in software, firmware, middleware or microcode, the program code or code segments to perform the necessary tasks may be stored in a machine-readable medium such as a storage medium or other storage(s). One or more than one processor may perform the necessary tasks in series, distributed, concurrently, or in parallel. A code segment may represent a procedure, a function, a subprogram, a program, a routine, a subroutine, a module, a software package, a class, or a combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted through a suitable means including memory sharing, message passing, token passing, network transmission, etc. and are also referred to as an interface, where the interface is the point of interaction with software, or computer hardware, or with peripheral devices.

In the following description, certain terminology is used to describe certain features of one or more embodiments of the invention.

The term “virtual reality” (VR) refers to a computer-generated simulation of a three-dimensional image, device, construct, environment, or a portion of any of these, that can be interacted with in a seemingly real or physical way by a user.

The term “mixed reality” (MR) refers to the merging of a view of a real-world environment and any of diverse aspects of a computer-generated environment, items, or elements thereof, one in which physical and virtual objects may co-exist in mixed reality environments and with which users may interact with and modify in real time.

The term “augmented reality” (AR) refers to a technology that superimposes a computer-generated image in two dimensions or three dimensions on a user's view or perception of the real world, thus providing a composite view, and a composite of other sensory modalities, such as, spatial audio.

The term “extended reality” (XR) refers to all variations and combinations of real-and-virtual combined environments and human-machine interactions in any combination of sensory modalities generated by computer technology and wearable devices, including AR, MR, VR, and XR, amongst others.

The terms “gesture command” and “gestural command” define a command to the system 100 that the system 100 interprets by recognizing, using one or more than one cameras whose signals are interpreted in real time by machine vision methods. Those camera systems interpret one or more than one specific motions of one or more than one hand and arm, or gaze direction, and provide that interpretation to the system 100 to interpret. The system 100 executes the one or more than one gesture command 208, as though it were a verbal or textual command. Gesture commands 208 can be simple, such as, point to a location, or complex, such as, sweep the hand or controller at arm's length on a curvilinear path of arbitrary length and position that has a beginning point and an end point. When the system 100 interprets and executes the gesture command 208, it may be integrated with other elements of the command that have been issued in one or more than one other signaling modalities, such as voice commands.

The term “digital twin” refers to any virtual representation of a physical object or location, typically but not limited to 3D.

The term “voice command” refers to spoken words by a user that are interpreted by the system using an AI/ML process to derive the meaning and intent of the words.

The terms “Artificial Intelligence” (AI) and “Machine Learning” (ML) refer to a process or procedure that learns from knowledge and experience, adjusts to new inputs, and perform human-like tasks using natural language processing and a diversity of algorithms on large amounts of data for recognizing patterns and performing critical analysis, such as, using voice as one of multiple different command modalities and in combination with others. The two terms can be used together, such as, AI/ML.

The term “location” refers to any area that is to be virtually mapped by a user, whether it is an indoor location bounded by walls, the outdoor elements of a structure, or an unbounded outdoor area, such as a playground or organized sports field.

The term “penetration” refers to any virtual representation, typically but not limited to 3D, that serves as the real-time digital counterpart of a physical object or process, such as, a door or a window that constitutes a void/hole through or within a larger virtual object.

The term “extrusion” refers to any virtual representation, typically but not limited to 3D, that serves as the real-time digital counterpart of a physical object or process, such as, a bump, balcony, awning, or porch, that constitutes an extension from a larger virtual object, at an arbitrary scale relative to the larger virtual object.

The term “wall” refers to a virtual plane that is in a digital twin.

Various embodiments provide a platform agnostic system 100 for spatial synchronization of multiple physical and virtual locations. One embodiment of the present invention provides a platform agnostic system 100 for spatial synchronization of physical and virtual locations.

In another embodiment, there is provided a method for using the system 100. The system 100 and methods therein will now be disclosed in detail.

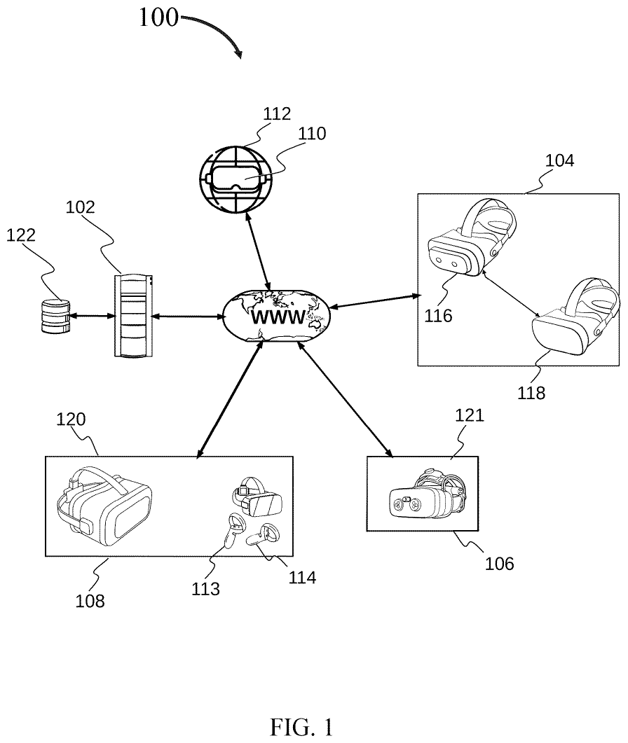

Referring now to FIG. 1, there is shown a diagram of a system 100 for a platform agnostic system for spatial synchronization of physical and virtual locations that provide user experiences to be created where local and remote users can interact, according to one embodiment of the present invention. The system 100 comprises one or more than one central server 102, wherein the one or more than one central server comprises 102 one or more than one processor. One or more than one XR headset 104, 106, 108 operably connected to the one or more than one central server 102, wherein the XR headset 104-108 comprises one or more than one processor. One or more than one XR hand controller 113 and 114 is operably connected to the one or more than one XR headset 107-108. Additionally there are instructions executable on the one or more than one central server 102 and the one or more than one XR headset 104-108. First, mapping one or more than one physical location into a digital twin 110. Then, mapping one or more than one shared XR virtual environment 112. Next, interacting with the one or more than one shared XR virtual environment 112. Then, tracking one or more than one user accurately in both the physical and the one or more than one XR virtual environment 112 without needing expensive equipment external to the user's one or more than one XR headset 104-108 integrated display, wherein the executable instructions are platform agnostic. Finally, controlling the XR virtual environment 112, assets, content, theme, script/narrative, and interactions in real-time.

The one or more than one user can be physically co-located 104, remotely located 120 and 121. Additionally, the one or more than one XR headset 104-108 can interact with one another 116 and 118.

A storage 122 is provided to store event logging, casting, session recordings, user profiles, one or more than one XR virtual environment 112, digital twins 110, and system commands and instructions, among others. Optionally, the storage 122 can be a database.

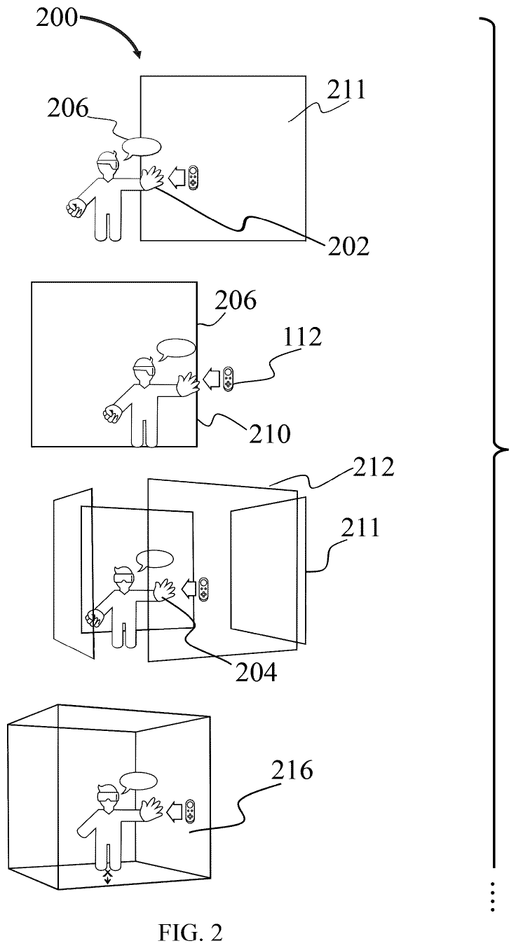

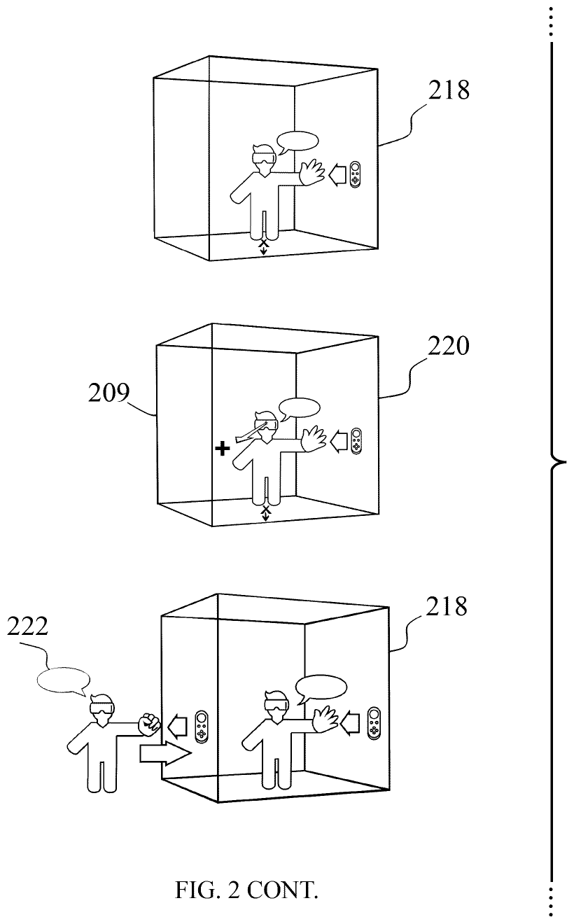

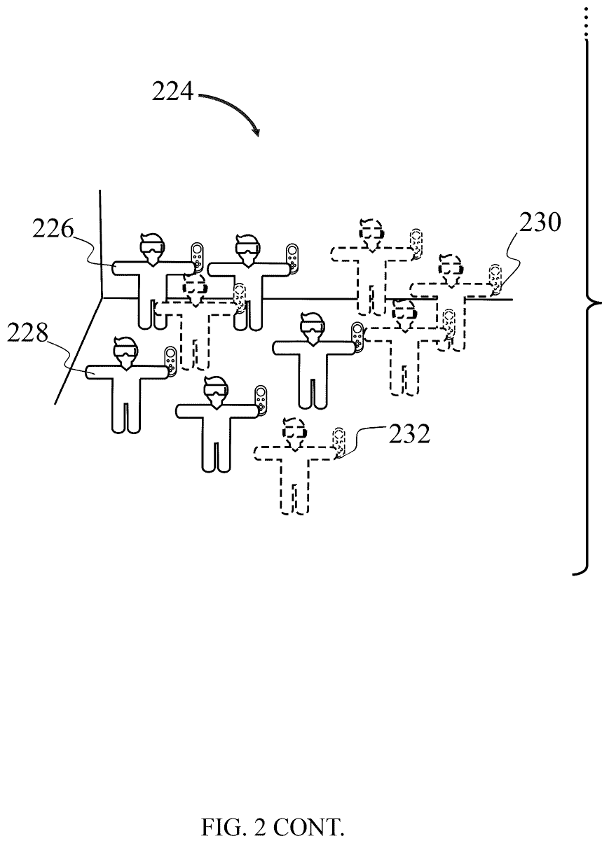

Referring now to FIG. 2, there are shown multiple workflow diagrams of a virtual 3D mapper useful in the platform agnostic system 100 for spatial synchronization of multiple physical and virtual locations that provide user experiences to be created wherein the users can interact, according to one embodiment of the present invention.

As will be understood by those with skill in the art with reference to this document, virtual 3D mapping is not limited to only these systems and methods, other spatial synchronization processes can also be used.

The system 100 performs spatial synchronization of physical users using one of a variety of methods as described herein below. Using a hand/voice/gesture synchronization method, first, a user touches an XR controller or hand against one end of a location and presses one or more than one XR hand controller 113 and 114 button, states a verbal command, uses a gestural command, or a combination of these commands to identify a first point. Note that voice commands are handled by an AI/ML process to interpret actionable commands, such as, actions or objects. Then, the user moves to a second point 210 and presses a second controller button or the same controller button, or states a verbal command, executes a gestural command or a combination of these commands to identify a second point 210. Next, the system 100 calibrates the alignment and rotation of the wall using the first point and the second point 210. Then, the system 100 generates a virtual wall defined by the first point and the second point 210. Next, the user repeats each step for each wall in the location for any number of walls. Next, the user may repeat each step for any penetrations 304 in the walls, such as, a door or a window. The steps for any penetrations may optionally be used during the use of the steps for establishing a plane or wall. Any extrusions 302 in the virtual planes 211, such as, a balcony or an awning can also be entered by the user. The steps for any extrusions may optionally be used during the use of the steps for establishing a plane or wall. The XR virtual environment 112 includes setting the base heights and vertical dimensions of the penetrations 304 and extrusions 302. Optionally, the user can generate a ceiling, using the system 100.

A second method for spatial synchronization of physical and virtual locations comprises plotting a plurality of reference points 200 by: first, when wearing one or more than one XR headset 104, 106, 108, the user looks at or touches, with one hand, or one or more than one XR hand controller 113 and 114, a first location identifying a first point 202. Optionally, the user can place the user's hand 204 at that location and state a voice command 206, use a gesture command 208 or press a controller button on the one or more than one XR hand controller 113 and 114, or a combination thereof, establishing the first point in 3D-space. When using a voice command 206 alone or in combination, the system 100 transmits the voice command 206 to an AI/ML process that interprets the voice command 206 and transmits the appropriate instructions back to the one or more than one central server 102. Then, the user selects a second point 210 in the location and provides a voice command 206, a gesture command 208, or presses a controller button on the one or more than one XR hand controller 113 and 114, or a combination thereof, thereby defining a wall or virtual plane 211 in the 3D space. The system 100, then executes instructions for calibrating, aligning, and rotating 212 of the virtual plane 211. Next, the user repeats the steps above for each location the user wants to create a wall or virtual plane 211. Finally, after all walls or virtual planes 211 are placed by the user, the system 100 maps the virtual planes 211 together when the user states a voice command 206, a gesture command 208, presses one or more than one XR hand controller's 113 114 button, or a combination thereof.

The XR virtual environment 112 the location is generated by the system 100 with dimensions to scale and the user's position is synchronized in the XR virtual environment 112 relative to the XR virtual environment 112. Horizontal dimensions of doors, windows, and other penetrations 304, or negative spaces, are created, during or after creation of each virtual plane 211, or after merging the virtual planes 211, using a voice command 206, a gestures command, pressing a button on the one or more than one XR hand controller 113 and 114, or a combination thereof. Vertical dimensions of the penetrations 304 can be defined by the same methods, assigning a ‘top’ and ‘bottom’ point location to each penetration. The horizontal and vertical measurements merge to form a 2D penetration, such as, doors and windows. Similarly, heights can be defined, using one point per height in the virtual plane 211.

Alternatively, in addition, to save a persistent spatial anchor of the user's position, the user stands on a marked synchronization point in the location, or places the one or more than one XR hand controller 113 on a static marked point on a user selected point and synchronizes and stores the selected point as a persistent spatial anchor of the user's position in the database 124, by using a voice command 206, a gesture command 208, pressing a controller button 114 on the one or more than one XR hand controller 113, or a combination thereof.

Optionally, for greater location accuracy, the user aims a cross hair graphic 209 generated by the system 100 inside the one or more than one XR headset 104, 106, 108 at a point in the location, such as, on a wall or a floor, if the user is located inside, or another stationary object if the user is outdoors, before selecting the synchronization command to save a persistent spatial anchor of the user's position in the storage 124.

When the user or another user re-enters the system 100, the user simply touches the previously stored static marker with the user's hand or one or more than one XR hand controller 113 to recall the XR virtual environment 112. Optionally, the user can stand in the marked synchronization point, stored when the XR virtual environment 112 was created, then, using a voice command 206, a gesture command 208, or pressing a button on the one or more than one XR hand controller 113, or a combination thereof. The user is synchronized to the XR virtual environment 112 and with any other users that enter. Alternatively, multiple XR systems provided for users can be ganged to be pre-synchronized at one time for groups of users by the same methods. Real-world position is then re-synchronized and all co-located users can move about freely.

Other users who are not local, but instead are remote, may connect to the synchronized XR virtual environment 112 as avatars and appear and interact identically to the local users. They may use controllers for interaction, as in the illustration, or voice or gesture commands 208, or a combination thereof. Optionally, the 3D model of the XR virtual environment 112 is modified from the immersed perspective of a user.

The XR virtual environment 112 can be exported as a 3D model for further customization in third-party tools such as Unity or Unreal Engine.

When the user re-enters the system 222, the user simply touches the previously defined wall or virtual plane 211 or stands in the synchronization spot saved to the storage 122 when the XR virtual environment 112 or digital twin 100 was created and gives a voice command 206 or a gesture command 208. The user's real-world position is then re-synchronized to the XR virtual environment the user can move about freely.

Any number of additional users 224 can enter the XR virtual environment that are either co-located in the same location 226 and 228 or from remote locations 230 and 232.

A second method is to create a planar part, similarly, to creating a wall. First, the user places the controller or a hand at two different locations to define a plane, using one or more than one XR hand controller 113 and 114, a voice command 206, a gesture command 208 or a combination thereof. When using the voice command 206, there are instructions transmitted from the one or more than one central server 102 to one or more than one AI/ML servers that interpret the command and returns an action to the one or more than one central server 102. Second, to describe additional dimensions of a plane or more than one plane, the user similarly places a plurality of locations using the one or more than one XR hand controller 113 and 114, a voice command 206, a gesture command 208 or a combination thereof. Next, the user executes a command to finish the object, using the one or more than one XR hand controller 113 and 114, a voice command 206, a gesture command 208 or a combination thereof. Virtual parts created using this method can be assembled and edited with other virtual parts created as described above. These parts can be assembled and edited with other virtual parts and models acquired from a database 124 or from a third party provider in the XR virtual environment 112 using methods comprising instructions executable on the system 100 that will be familiar to practitioners experienced in the art. Similarly, ceiling heights can be defined, using one point per height.

The user can also access a menu of additional items, such as, detailed penetrations 304, doors, windows, furniture, and other interior and exterior 3D models, to be placed in the mapped or other XR virtual environment 112. The user can use the one or more than one XR hand controller 113, a voice command 206, a gesture command 208, or a combination thereof, to select the additional items from a menu.

Implementations of the system 100 herein described embody benefits in usability, speed, and utility beyond prior art, tools, and products in the marketplace. The system 100 is intended for both professional use, such as, enterprise applications, expert designers, etc., in a broad range of industries, and for general use, such as, educators, trainers, hobbyists, gamers, students, artists, and children.

The system 100 also provides a user customizable library for user customizable objects and other assets, such as, materials, finishes, lighting, and functions that can be readily added to the digital twin 110 or other XR virtual environment 112. In one category of usage, to enhance the XR experience, the XR digital twin 110 or other XR virtual environment 112 can be custom-themed by users to support various gaming, instructional, educational, and other fantasy or real location designs.

The system 100 also provides the ability to easily import user-supplied or created content, whether partly or entirely user-generated on existing or future platforms, in a variety of file formats, into the user's or another user's XR digital twin 110 or other XR virtual environment 112. In the case of architectural and engineering use, content includes but is not limited to furniture, fixtures, and equipment. Options include: construction specifications, infrastructure such as wiring, cabling, HVAC, sensor systems, plumbing, and control systems, surface types and treatments, reflectance properties, materials properties, pricing models, lead times, ordering, contingent factors, and other data germane to design, development, inspection, review, construction, and operational use.

As can be seen, using one or more than one XR hand controller 113, a voice command 206, or a gesture command 208, the user can correctly, quickly, and accurately position virtual planes 211 of a physical location into an XR virtual environment 112, as described in the steps below. Thus, creating a 3D representation of the location, with accurate penetrations 304, such as a door or a window, extrusions 302, such as, balcony, or awning and ceiling height can be entered into the XR virtual environment 112 from additional data points. The user establishes a plurality of reference points per location of a virtual plane, or portion thereof, iteratively, to plot the layout of an entire location for an aligned digital twin 110 with optional virtual elements of that physical location.

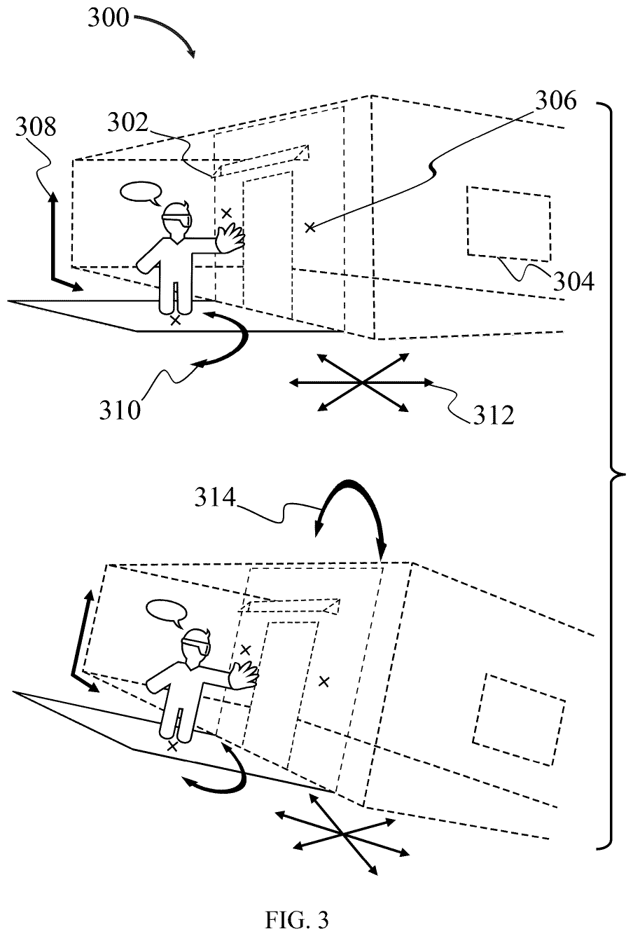

Referring now to FIG. 3, there is shown a diagram of user interaction with a digital twin 300. As can be seen, the system 100 enables a user to easily and quickly translate 312, rotate 310, scale 308, or tilt 314 a digital twin 110, or other XR virtual environment 112, models, or portion thereof, on any axes. The digital twin 100 or any virtual elements 302 can be arbitrarily scaled 308 or changed for the user and any other users present in the XR virtual environment 112. The user can also maneuver the digital twin 110 or model to any position, orientation, scale, and/or view the user chooses in the XR virtual environment 112.

The system 100 also comprises instructions operable on one or more than one process for a user to extensively modify and edit 306 a digital twin 110, other acquired 3D models, and to create and build new objects and models that can be edited, modified, adjusted and combined in diverse ways while within an XR virtual environment 112.

When a user has finished mapping a digital twin 110 of a location using the virtual 3D mapper, or during the user's mapping process, the user can add penetrations 304, such as, doors, windows, or other negative spaces, into the location. The user can also add extrusions 302, such as, awnings, balconies porches, stairways. In addition, the user can also create, such as, draw or sketch in 3D, using controller and hand gestures 208, and/or voice commands 206, to make and edit a 3D XR file, such as, a shape, a building, or an object, and save it, without mapping a physical form. When using a voice command 206 alone, or in combination with other available commands, one or more than one AI/ML server interprets the commands that are executed on the one or more than one central server 102.

Adding and placing penetrations 304 can be done by pointing a user's hand or one or more than one XR hand controller 113 at one or more than one location and pressing a controller button, a voice command 206 or a gesture command 208 or combination thereof for each location pointed at. In the method of placing corners of penetrations 304. After setting one or more than one corners, the user merges the corners by a command, using the same controller button or a different controller button 114, or a voice command 206 or gesture command 208, or a combination thereof, to form a penetration, such as, a door or a window. In the method of placing a penetration by setting the sides, the user first sets two points of a location, either indoors or outdoors, bounded or unbounded similarly to defining a wall elsewhere in this patent. The second step is to set two more points to define the top and bottom sides of the penetration. The third step is to merge the points by issuing a command using the same controller button 114, a different controller button 114, a voice command 206, a gesture command 208, or a combination thereof, to form a penetration, such as, doors, windows. In the method of creating and placing a penetration by voice, user verbally describes dimensions and other features of the item, such as, color, texture, reflectance, or density, to invoke it, and verbally describes its position and orientation to place it. When using voice command 206 alone or in combination, one or more than one call to one or more than one AI/ML servers interprets them. Optionally, gesture commands 208 can substitute for some verbal descriptions, such as, size, location, orientation.

Adding and placing extrusions 302, such as, awnings, balconies, porches, stairways, can be done by accessing complete virtual items and placing them in the XR virtual environment 112, or by building them and then placing them. Building an item can involve one or more simple or complex gestures with hand and controller, as well as voice descriptions. When using voice commands 206 alone or in combination, one or more than one call to one or more than one AI/ML servers interprets them. Simple or complex 3D models can be invoked by voice command 206 and scaled, spatially translated, and skinned using a controller 113, voice command 206 or gesture command 208, or combination thereof, to then complete and save the resulting 3D file. Optionally, the user may create additional files and edit them singly and jointly, using the system's functions to execute methods familiar to a practitioner in the art.

After the users are synchronized in the system 100 by any combination of the above and other methods, the system 100 enables real-time tracking, free-roaming, and multi-sensory social interaction of both local and remote users in a single shared XR virtual environment 112. The system 100 is scalable in any instance for any number of users and also allows for centralized synchronization by an operator over any number of headsets prior to user distribution. The system 100 supports the synchronized global participation of distant remote users. Digital twinning of physical location, easy setup, and layout of multiple experience locations, identical or different, using proprietary systems. Tracking physical objects, such as, wands, pens, swords, vehicles, furniture, etc., motion tracking technology, and enabling them to appear in the XR virtual environment 112 with the correct scale.

The system 100 can quickly change the synchronized, multi-user, physical location's content or ‘scene,’ or instantly invoke a different, new set of content, or any combination of new and existing content. The system 100 can switch the content while retaining the avatars of current users, to effect a different XR experience in the same physical site, either within the same virtual-world platform, or imported from a different virtual-world platform, all in the originally synchronized facility's physical location, creating a new XR virtual environment 112 for users easily and quickly. The new XR virtual environment 112 also typically but not necessarily includes an entire 3D dataset.

The system 100 also provides accurate tracking of local XR users in the physical location, and of physical objects, along with multi-platform seamless integration of remote players into a local shared XR virtual environment 112.

The system 100 is hardware-agnostic, 3D file-agnostic, cross-platform, and integrates local and remote users into a shared XR virtual environment 112, including users of flat-screen displays and also mobile platforms. The system 100 provides flat-screen display users navigation within the system 100 and the users can perform actions on elements in the XR virtual environment 112. Also, the flat screen display users can interact with other local and remote users wearing headsets or not. The system 100 includes a real-time, spatially accurate, multi-user voice communication system. The system 100 also includes real-time monitoring of interactive sessions and user actions and interactions, with optional event logging, session recording, and casting. Moreover, the system 100 includes real-time control over the XR virtual environment's 112 assets, such as, content. Assets include, but are not limited to, 3D models of XR virtual environments 112 and objects, lighting, illumination, materials, surfaces, finishes, interactive functionality, script/narrative, and interactions.

The system 100 provides a wide range of control over any XR virtual environment 112. For example, skinning/theming for events, such as, Halloween, Christmas, Thanksgiving, New Years, Hanukkah, Kwanzaa, etc. Or, for events such as educational classes and training, rehearsals, birthday parties and Quinceañera fiestas, corporate product events, celebrity branded events, military maneuvers, and training, among others.

The system 100 has an automatic standard generic profile that is generated automatically for every new user, with prompts to customize it, and, separately, incremental auto-updating of a log of real user behavior data from user's visits, with required permissions. The custom profile is managed and adjustable by other defined super-user roles than the actual user, and accretes over time for each returning user. Optionally, the user's custom profile can be monetized in a variety of ways as well as delivering relevant content, activities, benefits, and a variety of user capabilities in the XR virtual environment 112 based on their profile or role.

The system 100 further has the capability for users to access saved, persistent, user-created content created by themselves or others, such as, for example, generic sandbox-built content or platform content from existing worlds such as, such as: ROBLOX®, Universal®'s Harry Potter® theme park experiences, geospatial or satellite data for government and private uses or applications, or branded or corporate content.

The system 100 also has the following functionality:
Group registration and record-keeping, session-recording, and session playback/reviewing
User profile and activity metrics
Users and team leaders can access their stats and access session media. (applies to both play and enterprise, among others)
Features that support enterprise use: logging, attendance, scoring, reporting, playback, and access rights
Rewards and achievement system
Merchandise access, purchase, and subscription
Ambassador and super-user support features
Persistent world support
Community support tools
Consistent User Experience across all industries and platforms:
User Registration
Player Profiles including types of user data, a maximum number of guests allowed to enter the XR space, with graceful degradation of Quality of Service (QoS) under high loading
User determined geo-location features
Assignment of payment details
Invoke a selected XR world framework
Importation of a user's own existing content from an existing platform
Invitation to other users; name and/or identifier (friends list)
Registration system for invited players
Payment methods for invited users, or host adds the invited users to the inviter's account
Automated payment or free-to-play as an invitee for pre-determined time period
An easy, seamless log-out, leave session, with automatic progress saving
Content creation and asset management support for developers
Multiplayer support for player-and-scene synchronization
Set up for local-and-remote or local-player-only experiences
Avatar system for easy customization and/or avatar creation
Inverse Kinematics or similar system for real-time avatar rig positioning, synchronized to a user's hands
Custom hand model and gesture-recognition support
Custom controller model system for various assets such as guns, wands, etc.
Dynamic skinning system and server automation to allow real-time scene changes
Persistent XR world support assets, typically but not limited to objects and processes that vary over time, such as, for example: a tree growing in between sessions, weather catastrophes, etc.
Live Worlds—prefab assets for supporting dynamic environments, such as flocking, herd, and other group behavior features for birds, fish, animals, insects
A particle system library

The system 100 incorporates an AI or ML non-player character (NPC) action system that is both context-adaptive and continuously self-personalizing per user. User data of interaction outcomes is collected to drive a macro level ML action system for control of non-player characters in an XR virtual environment 112. The non-player characters are from the user's point of view and have no understanding of gameplay, interaction goals, etc. That is, they are only provided information that is needed for the non-player character to exist and interact in appropriate scenarios in a specified XR virtual environment 112 and user-session context. That information may be factual or contextual, verbal, gestural, or behavioral. The AI or ML action or reaction sets can be auto-adjusted to suit user skill levels in the user's profiles and synchronize across all users in the system 100. For commercial applications, the AI or ML action or reaction sets can provide an expert, contextually adaptive, dialogue-driven assistant system for inspection, compliance, training, education, and content creation in a diversity of media, recommendation, entertainment, optimization scenarios and applications, among others.

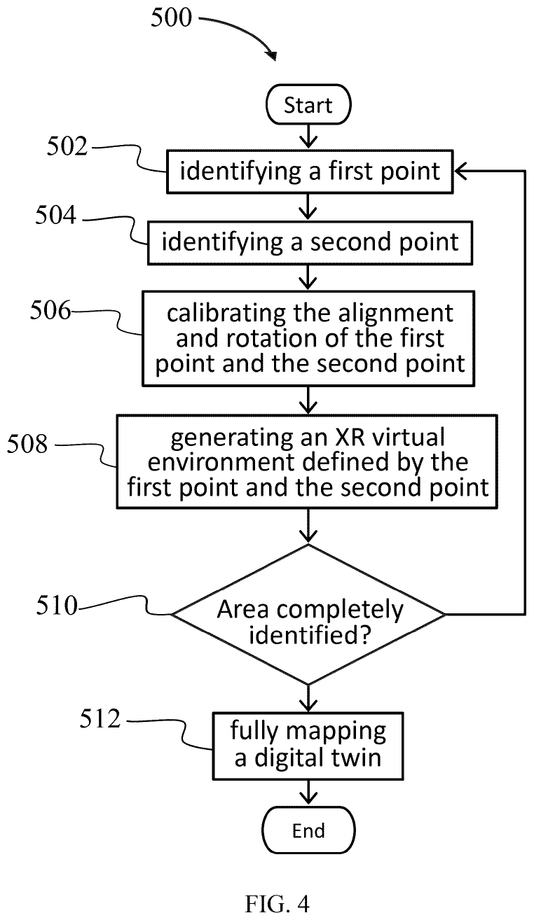

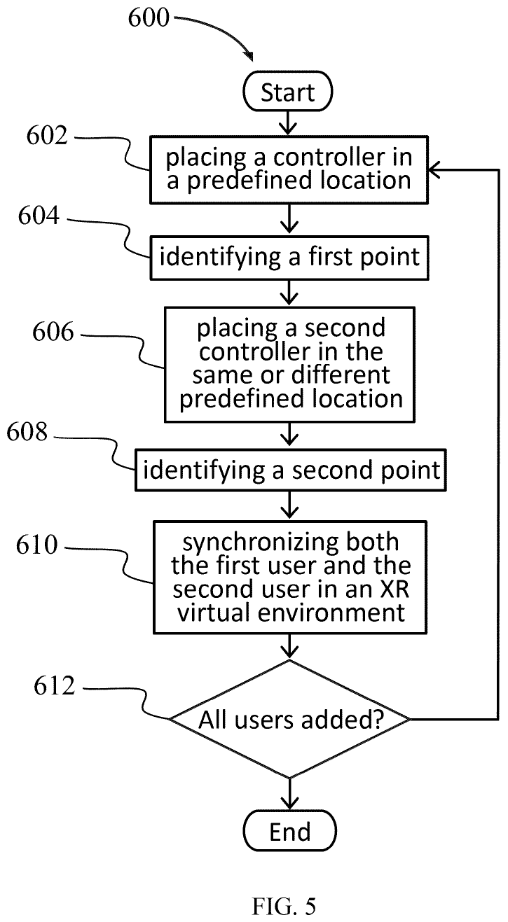

Referring now to FIG. 5, there is shown a flowchart diagram 500 of some instructions for one or more than one user to iteratively plot a plurality of reference points for the layout of an entire physical location to create an aligned digital twin of the physical location and any additional virtual features that are not present in the physical location. First, identifying a first point 502 by touching the one or more than one XR hand controller or the user's hand at a first point and pressing a first XR hand controller button 114, issuing a voice command 206, a gesture command 208 or a combination thereof. Then, identifying a second point 504 by moving to a second point and pressing a second XR hand controller button 114, issuing a second voice command 206, a second gesture command 208 or combination thereof. Next, calibrating the alignment and rotation 506 of the first point and the second point 210. Then, generating an XR virtual environment defined by the first point and the second point 508. Next, repeating 510 the steps above in the physical location until the area is completely identified. Finally, fully mapping a digital twin 512 of the physical location in the XR virtual environment 112 by pressing a third XR hand controller button 114, issuing a third voice command 206, a third gesture command 208, or a combination thereof, to merge the points and any additional virtual penetrations 304, extrusions 302, or other virtual features.

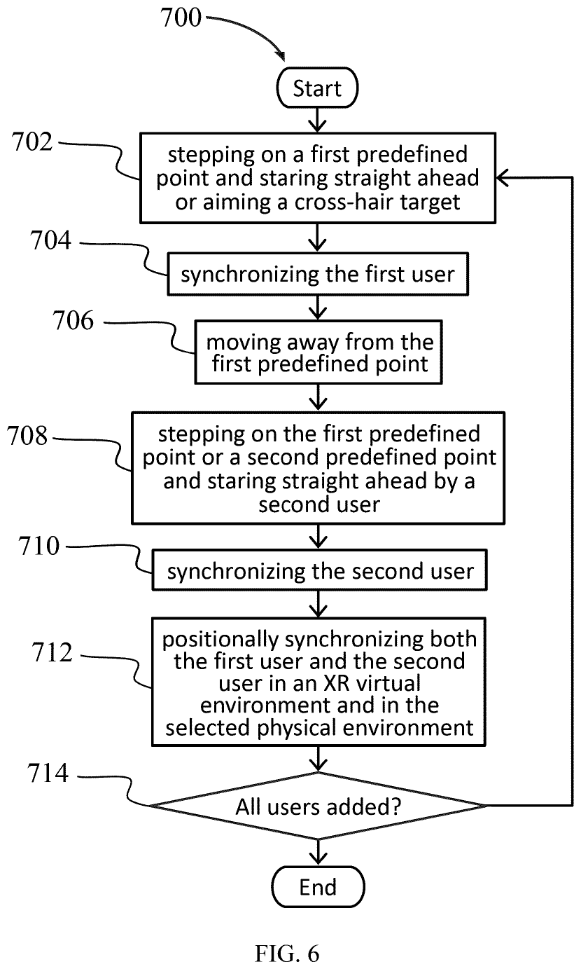

Referring now to FIG. 6, there is shown a flowchart diagram 600 of some steps of a method for controller synchronization of one or more than one user in an XR virtual environment. first, placing a controller 113 in a predefined location 602 by a first user. Then, identifying a first point 604 by pressing a first button 114 on the controller 113, issuing a first voice command 206, or a first gesture command 208 by the first user. Next, placing a second controller in the same or different predefined location 606, by a second user. Then, identifying a second point 608 by pressing a second button on the second controller, issuing a second voice command 206 or a second gesture command 208 by the second user. Next, synchronizing both the first user and the second user 610 in an XR virtual environment 112 bounded by a location and apparatus, enabling both the first user and the second user to move about the location and apparatus and the XR virtual environment 112 freely. Finally, repeating steps above to add additional users 612.

After the users are synchronized, the system provides real-time tracking, free-roaming, manipulation and interaction with some virtual elements, and social interaction of the one or more than one user in both the physical location and the XR virtual environment 112 in a single shared XR virtual environment 112, wherein the system is scalable in any instance for any amount of users located anywhere. Optionally, this method uses incorporate fingerprint, retina scan, or other biometric identification means to automatically identify and log users entering or leaving the XR virtual environment 112 or scenario.

Referring now to FIG. 7, there is shown a flowchart diagram 700 showing some steps of a method for headset synchronization of one or more than one user in an XR virtual environment 112. First, a first user steps on a first predefined point and staring straight ahead 702. Then, synchronizing the first user 704 by the first user pressing a first button 114 on a first controller 113, using a first verbal command 206, using a first gesture command 208, or a combination thereof. Next, moving away from the first predefined point 706 by the first user. Then, stepping on the first predefined point or a second predefined point and staring straight ahead by a second user 708. Next, synchronizing the second user 710 by the second user pressing a button 114 on a second controller 113, using a second verbal command 206, using a second gesture command 208, or a combination thereof. Then, positionally synchronizing the first user and the second user 712 in an XR virtual environment 112 and in the selected physical environment; wherein both the first user and the second user are able to move about the physical location and the XR virtual environment 113 freely. Finally, repeating 714 the steps above to add other users.

Alternatively, to enhance precision, while wearing the headset and standing on a predefined point, the second user views a cross hair graphic 209 in the XR headset 104-108 display, and orients the headset using the cross hair graphic 209 to a specified marker in the physical environment. The second user synchronizes with the XR virtual environment 112 using a button press 114, a hand gesture 208, a voice command 206 or combination thereof. Voice commands 206 are handled by AI/ML processes in the server 102 to interpret actionable commands, such as, actions or objects. The first user and the second user are now synchronized positionally both in the XR virtual environment 113 and in the physical location and can move about and interact freely.

Additional users can be added using the methods disclosed herein. Online users can be freely added to the synchronized, combined virtual and physical experience and will appear in the XR virtual environment 112 as well, in spatial synchronization, at appropriate yet dynamically adjustable scale.

Optionally, fingerprint, retina scan, or other biometric identification means can be used to automatically identify and log users entering and leaving the XR virtual environment 112.

The system further comprises the step of displaying in the headset a cross hair graphic and orienting the headset using the cross hair graphic to a specified marker in the physical environment to enhance precision. After the one or more than one user is synchronized, the system 100 enables real-time tracking, free-roaming, manipulation of and interaction with virtual elements, and social interaction of the one or more than one user in both the physical location and the remote XR virtual environment 112 in a single shared XR virtual environment 112. The system 100 is scalable in any instance for any amount of users located anywhere. The system 100 also has instructions for tracking physical objects using one or more than one motion tracking technology, and having the physical objects appear in the XR virtual environment 122 with the correct features.

What has been described is a new and improved system 100 for a platform agnostic system for spatial synchronization of multiple physical and virtual locations that supports multi-user experiences to be created or experienced where local and remote users can easily interact with one another and with the XR virtual environment 112 and portions of it, in a diversity of ways, overcoming the limitations and disadvantages inherent in the related art.

Although the present invention has been described with a degree of particularity, it is understood that the present disclosure has been made by way of example and that other versions are possible. As various changes could be made in the above description without departing from the scope of the invention, it is intended that all matter contained in the above description or shown in the accompanying drawings shall be illustrative and not used in a limiting sense. The spirit and scope of the appended claims should not be limited to the description of the preferred versions contained in this disclosure.

All features disclosed in the specification, including the claims, abstracts, and drawings, and all the steps in any method or process disclosed, may be combined in any combination, except combinations where at least some of such features and/or steps are mutually exclusive. Each feature disclosed in the specification, including the claims, abstract, and drawings can be replaced by alternative features serving the same, equivalent, or similar purpose, unless expressly stated otherwise. Thus, unless expressly stated otherwise, each feature disclosed is one example only of a generic series of equivalent or similar features.

Any element in a claim that does not explicitly state “means” for performing a specified function or “step” for performing a specified function should not be interpreted as a “means” or “step” clause as specified in 35 U.S.C. § 112.

What is claimed is:

1. A computer implemented platform agnostic system for spatial synchronization of physical and virtual locations that provide user experiences to be created or where local and remote users can interact, the system comprising:
a. One or more than one central server, wherein the one or more than one central server comprises one or more than one processor;
b. one or more than one XR headset operably connected to the one or more than one central server, wherein the XR headset comprises one or more than one processor; and
c. instructions executable on the one or more than one central server and the one or more than one XR headset for:
1) mapping one or more than one physical location into a digital twin;
2) mapping one or more than one XR virtual environment;
3) interacting with the one or more than one shared XR virtual environment;
4) tracking one or more than one user accurately in both the physical and the one or more than one XR virtual environment without needing expensive equipment external to the one or more than one users' XR headset integrated display system, wherein the executable instructions are platform agnostic; and
5) controlling the XR virtual environment, assets, content, theme, script/narrative, and interactions in real-time.

2. The system of claim 1, further comprising one or more than one XR hand controller and a real-time, spatially accurate, multi-user voice communications system operably connected to the one or more than one XR headset.

3. The system of claim 2, wherein the one or more than one user is co-located with other users in a physical location and with other non-collocated users virtually join each other in the physical location to have a common experience in the XR environment where the users can interact with each other.

4. The system of claim 2, wherein the user can correctly, quickly, and accurately position virtual bounding walls and elements of a physical location, creating a digital twin with accurate lengths and heights of the physical location using the one or more than one XR hand controller, one or more than one voice command, one or more than one gesture command, or a combination thereof.

5. The system of claim 4, wherein the system comprises instructions for one or more than one user to iteratively plot a plurality of reference points for the layout of an entire physical location to create an aligned digital twin of the physical location and any additional virtual features that are not present in the physical location, the instructions comprising:
a. identifying a first point by touching the one or more than one XR hand controller or the user's hand at a first point and pressing a first XR hand controller button, issuing a voice command, a gesture command or a combination thereof;
b. identifying a second point by moving to a second point and pressing a second XR hand controller button, issuing a second voice command, a second gesture command or combination thereof;
c. calibrating the alignment and rotation of the first point and the second point;
d. generating an XR virtual environment defined by the first point and the second point;
e. repeating steps a-b in the physical location until the area is completely identified; and
f. fully mapping a digital twin of the physical location in the XR virtual environment by pressing a third XR hand controller button, issuing a third voice command, a third gesture command, or a combination thereof, to merge the points and any additional virtual penetrations, extrusions, or other virtual features.

6. The system of claim 2, wherein the system comprises a library of objects and assets that can be quickly added to the digital twin or shared XR virtual environment.

7. The system of claim 2, wherein the digital twin or shared XR virtual environment can be configured to support various gaming and other fantasy or real location layouts.

8. The system of claim 2, wherein the system further comprises instructions to import or access saved, persistent, user-created content, and third-party content into the digital twin or XR virtual environment.

9. The system of claim 8, wherein the system further comprises instructions to add virtual elements to the existing XR virtual environment and modify or remove elements of the XR virtual environment, using mapping methods and save the resulting digital twin.

10. The system of claim 2, wherein the system further comprises instructions to scale, rotate, translate, tilt, and/or orient the digital twin or shared XR virtual environment, of an inside physical location or of an outside physical object, and outside physical location or another 3D model, to whatever size, orientation, and position selected by the user in the XR virtual environment.

11. The system of claim 2, wherein the system executes instructions for spatial synchronization of one or more than one user located in a physical location using a controller synchronization method, the controller synchronization method comprising instructions operable on a processor for:
a. placing a controller in a predefined location by a first user;
b. identifying a first point by pressing a first button on the controller, issuing a first voice command, or a first gesture command by the first user;
c. placing a second controller in the same or different predefined location, by a second user;
d. identifying a second point by pressing a second button on the second controller, issuing a second voice command or a second gesture command by the second user;
e. synchronizing both the first user and the second user in an XR virtual environment bounded by a location and apparatus, enabling both the first user and the second user to move about the location and apparatus and the XR virtual environment freely; and
f. repeating steps c-e to add additional users.

12. The system of claim 2, wherein after the users are synchronized, the system provides real-time tracking, free-roaming, manipulation and interaction with some virtual elements, and social interaction of the one or more than one user in both the physical location and the XR virtual environment in a single shared XR virtual environment, wherein the system is scalable in any instance for any amount of users located anywhere.

13. The system of claim 2, wherein the system performs spatial synchronization of one or more than one user in a physical location using a headset synchronization method, the headset synchronization method comprising instructions operable on a processor for:
a. stepping on a first predefined point and staring straight ahead by a first user;
b. synchronizing the first user by the first user pressing a button on a first controller, using a first verbal command, using a first gesture command, or a combination thereof;
c. moving away from the first predefined point by the first user;
d. stepping on the first predefined point or a second predefined point and staring straight ahead by a second user;
e. synchronizing the second user by the second user pressing a button on a second controller, using a second verbal command, using a second gesture command, or a combination thereof;
g. positionally synchronizing the first user and the second user in an XR virtual environment and in the selected physical environment; wherein both the first user and the second user are able to move about the physical location and the XR virtual environment freely; and
h. repeating steps a-f to add other users.

14. The system of claim 13, further comprising the step of displaying in the headset a cross hair graphic and orienting the headset using the cross hair graphic to a specified marker in the physical environment to enhance precision.

15. The system of claim 2, wherein after the one or more than one user is synchronized, the system enables real-time tracking, free-roaming, manipulation of and interaction with virtual elements, and social interaction of the one or more than one user in both the physical location and the remote XR virtual environment in a single shared XR virtual environment, wherein the system is scalable in any instance for any amount of users located anywhere.

16. The system of claim 2, wherein the system further comprises instructions for tracking physical objects using one or more than one motion tracking technology, and having the physical objects appear in the XR virtual environment with the correct features.

17. The system of claim 2, wherein the one or more than one user can quickly switch content with avatars of inhabiting users, to effect a different XR virtual environment experience or scenario in the same physical room, within the same XR virtual environment platform, or imported from a different XR virtual environment platform, all in the original physical location, creating new XR content, an XR virtual environment, or scenario easily and quickly; wherein the new XR virtual environment, content, or scenario also includes an entire 3D dataset.

18. The system of claim 2, wherein the system further comprises real-time monitoring of game sessions and user interactions, with event logging, casting, session recording and other functions.

19. The system of claim 2, wherein the system comprises a default automatic standard generic profile, is generated for every new user, with prompts to customize the profile.

20. The system of claim 19, wherein the customized profile is managed, accretes and incrementally auto-updates a log of the user's behavior data from each return visit, using artificial intelligence and machine learning methods to create an incrementally refined model of the user, to incorporate in real-time dynamic XR experience creation for the user and others;
wherein the artificial intelligence and machine learning sets are auto-adjusted to suit the user's skill level and are synchronized across all users in the system.
